(19) United States
(12) Patent Application Publication
(10) Pub. No.: US 2026/0049009 A1
(43) Pub. Date: Feb. 19, 2026

(54) WATER SANITATION SYSTEM

(71) Applicant: King Technology, Inc., Minnetonka, MN (US)

(72) Inventors: Daniil A. Rezekulov, Savage, MN (US); Daniel P. Longhenry, Bloomington, MN (US)

(21) Appl. No.: 19/300,482

(22) Filed: Aug. 14, 2025

Related U.S. Application Data
(60) Provisional application No. 63/683,112, filed on Aug. 14, 2024.

(51) Int. Cl. C02F 1/467; C02F 1/461; C02F 103/42

(52) U.S. Cl. CPC C02F 1/4674; C02F 1/46109; C02F 2001/46152; C02F 2103/42; C02F 2209/02; C02F 2209/04; C02F 2209/05; C02F 2209/06

(57) ABSTRACT

A water sanitation system for use in saltwater comprises an electrode cartridge removably couplable to a housing, the cartridge including a plurality of electrodes configured to generate oxidizing agents such as chlorine or bromine via electrolysis when powered. The housing includes an electrical connection to a power source and a plurality of electrode terminals in electrical communication with the power source, the electrode terminals configured to electrically engage the electrodes in a wet connection for power delivery while submerged.

### RELATED APPLICATIONS

This application claims priority to U.S. Provisional Application 63/683,112, filed Aug. 14, 2024, the entire contents of which are hereby incorporated by reference.

### FIELD OF THE INVENTION

The invention relates to water sanitations systems and more particularly, to water sanitation systems that employ electrolysis to produce halogens.

### BACKGROUND OF THE INVENTION

Water in hot tubs and spas can present an attractive environment for bacteria and viruses to grow, which can cause infection and disease. To maintain the spa water in a clean and sanitary condition, the water is normally passed through a filter which removes and collects particulate matter. Further, sanitation systems are used to maintain water conditions that discourage bacterial, fungal, and viral growth.

Electrolytic cells represent one way of sanitizing water for spas and pools. In an example of this arrangement, an amount of salt (e.g., sodium chloride) is periodically added to pool or spa water (e.g., a few times per year), an electric charge is imparted on the electrolytic cell, and water is pumped through the cell. Through electrolysis, the salt (sodium chloride) in the water is converted to free chlorine, which is subsequently pumped into the pool or spa to sanitize water. Over time, the electrodes of the electrolytic cells degrade and accordingly, the electrolytic cell requires replacement. Replacement of electrolytic cells, though, may be costly and difficult.

Electrolytic cells are often integrated into the water circulation system of a spa/pool, such as integrated with the pump, to mix generated chlorine with the water of the spa/pool. However, such a configuration requires the water circulation system to be running in order to be effective, thereby consuming more energy. Moreover, when integrated into the water circulation system, the replacement of an electrolytic cell can be difficult.

### BRIEF DESCRIPTION OF THE DRAWINGS

FIGS. 1A-B are perspective views of an example water sanitation system according to an aspect of the present disclosure.

FIG. 2 is a perspective sectional view of the example water sanitation system of FIG. 1B according to an aspect of the present disclosure.

FIGS. 3A-B are perspective views of an alternate example water sanitation system according to an aspect of the present disclosure.

FIG. 4 is a perspective sectional view of the example water sanitation system of FIG. 3B according to an aspect of the present disclosure.

FIGS. 5A-5C are perspective views of an alternate example water sanitation system according to an aspect of the present disclosure.

FIGS. 6A-6B are perspective views of an alternate example water sanitation system according to an aspect of the present disclosure.

FIGS. 7A-7C are perspective views of an alternate example water sanitation system according to an aspect of the present disclosure.

FIG. 8 is a perspective view of a spa including various possible placements of a water sanitation system according to aspects of the present disclosure.

### SUMMARY

An example water sanitation system includes an electrode cartridge removably couplable to a housing with the electrode cartridge comprising a plurality of electrodes configured to generate oxidizing agents when powered. The water sanitation system also includes a housing comprising an electrical connection to a power source and a plurality of electrode terminals. The plurality of electrode terminals are in electrical communication with the power source via the electrical connection. The plurality of electrode terminals are configured to electrically engage with the plurality of electrodes in a wet connection to provide power to the plurality of electrodes from the power source.

Another example water sanitation system includes a base comprising an electrical connection to a power source and a housing removably couplable to the base. The housing includes a plurality of electrodes configured to generate an oxidizing agent when power is provided to the plurality of electrodes. The plurality of electrodes are configured to receive power wirelessly from the power source through the housing and the base.

An example water monitoring sensor includes a water monitoring element configured to measure one or more properties of water and a first inductive element. The first inductive element is in electrical communication with the water monitoring element and with a second inductive element. The first inductive element is configured to receive power wirelessly from the second inductive element and provide the power to the water monitoring element. The first inductive element is further configured to transmit data wirelessly to the second inductive element using the first inductive element with the data comprising the measured one or more properties of water.

### DETAILED DESCRIPTION

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

In the present specification, anywhere the terms “comprising” or “comprises” are used, those terms have their ordinary, open-ended meaning. In addition, where appropriate, the disclosure at each such location is to be understood to also disclose that it may, as an alternative, “consist essentially of” or “consist of. ”

Additionally, anywhere the term “spa” is used, this term generally refers to any water chamber or water holder having a main seating area where one or more users sit in water, such as but not limited to hot tub, bath, whirlpool, jacuzzi, and pool.

Further, anywhere the term “water sanitation system” is used, this term generally refers to an electrolytic cell that is configured to generate oxidizing agents (e.g., ozone) including halogens (e.g., chlorine, bromine) in a fluid environment.

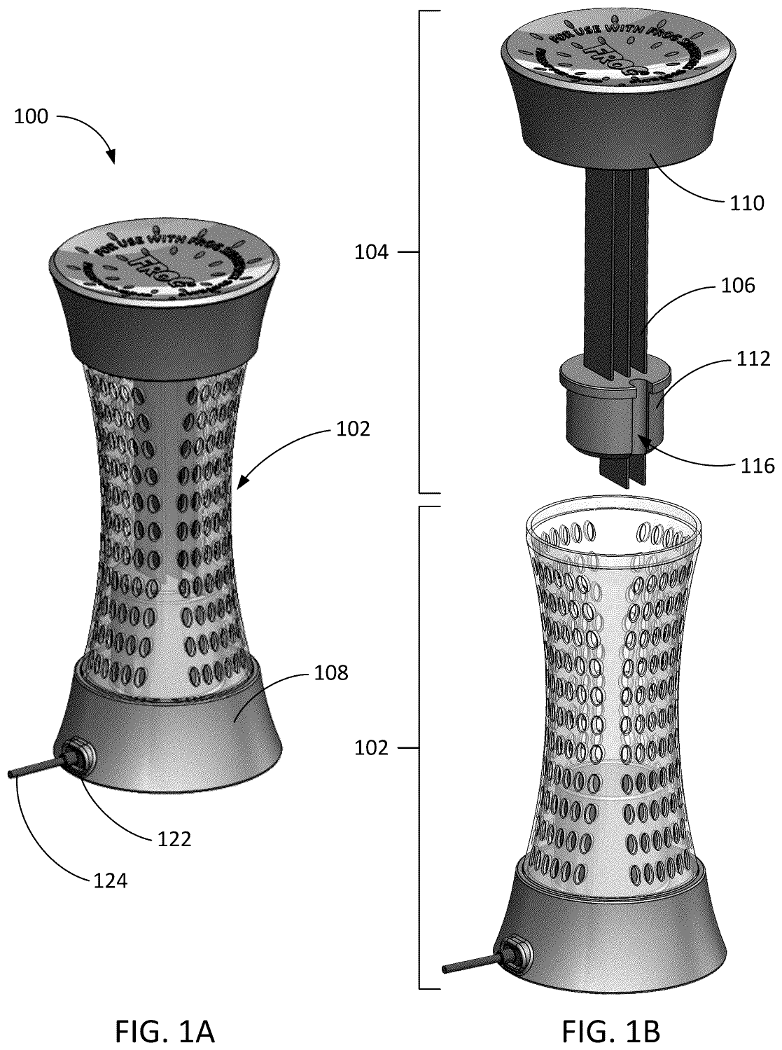

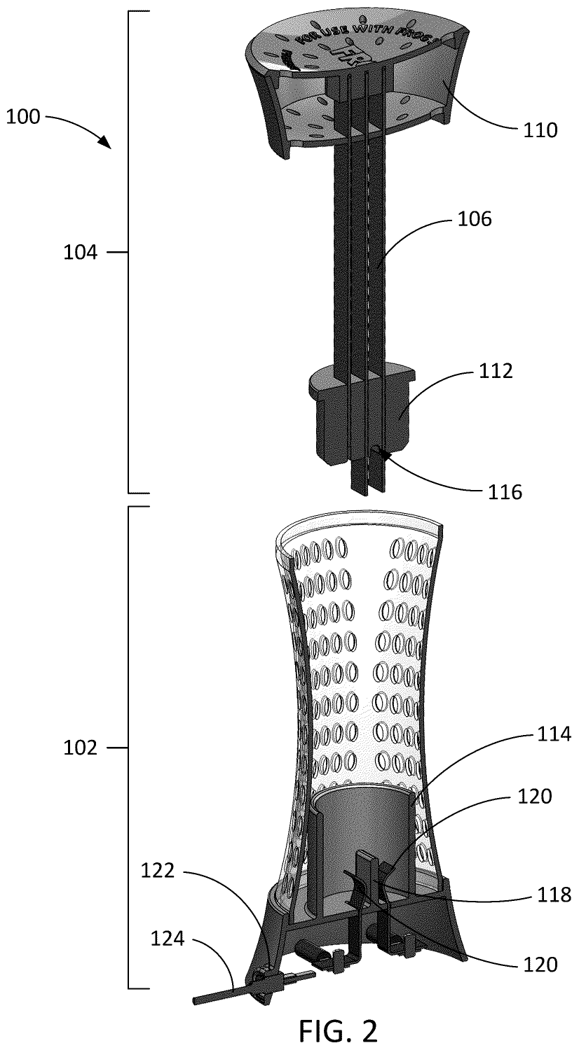

Referring to FIG. 1A-B, and FIG. 2, FIG. 1A and FIG. 1B are perspective views of an example water sanitation system 100 and FIG. 2 is a perspective sectional view of the example water sanitation system 100 of FIG. 1A-1B according to an aspect of the present disclosure. The water sanitation system 100, when submerged in saltwater, is configured to generate oxidizing agents (e.g., chlorine, bromine) via electrolysis of the saltwater. As one having ordinary skill in the art will appreciate, saltwater is not limited to sodium chloride water. The water sanitation system 100 includes a housing 102 and a cartridge 104 removably couplable to the housing 102. The cartridge 104 includes a plurality of electrodes 106 that when powered, perform electrolysis of the saltwater and generate oxidizing agents. To provide power to the plurality of electrodes 106 of the cartridge 104, the housing 102 is electrically connected to a power source and includes a wet connection to the plurality of electrodes 106 of the cartridge 104.

A wet connection, as used herein, is generally defined as an electrical connection whereby a receiving end is connected to a corresponding output end with both the receiving and output ends fully submersed in a fluid and able to pass power between them while submersed in the fluid. In some examples, the wet connection can be further limited to a connection where neither the receiving end nor the output end can electrically connect with themselves (e.g., short circuit). For instance, in one such example, a wet connection would not include an output end which electrically conducts when submersed in a fluid without being connected to a corresponding receiving end.

Over time, the electrodes 106 of the cartridge 104 can wear down. For example, the electrodes 106 can wear due to performing electrolysis with the wear taking the form of fouling of the electrodes and/or dissolving of the metal of the electrodes. However, because the cartridge 104 is removably couplable to the housing, the cartridge 104 can be easily removed and replaced with a new cartridge having new electrodes. Thus, instead of needing to replace an entire assembly, as in existing systems, only the cartridge 104 is replaced. Further, because the connection between the housing 102 and the plurality of electrodes 106 of the cartridge 104 is a wet connection, the housing 102 can be fully submerged and the cartridge 104 can be easily replaced with the housing 102 fully submerged. No special care, such as draining the spa/pool, is necessary to replace the cartridge 104.

Continuing with the example water sanitation system 100 of FIG. 1A/B and FIG. 2, the housing 102 includes a housing base 108. In some examples, the housing base is separate and distinct from the housing. However, in the illustrated embodiment, the housing base 108 is part of the housing 102 and accordingly, the housing 102 refers to the combination of the housing 102 and the housing base 108. The housing base 108 can house an electrical connection to the power source and can be watertight.

The cartridge 104 that is removably couplable to the housing 102 includes a top portion 110 and a bottom portion 112 that hold the plurality of electrodes 106. In the illustrated embodiment, the cartridge 104 includes three electrodes with the outer electrodes being electrically shorted together. However, the cartridge 104 can include any number of electrodes, such as two or greater electrodes. One or more of the two or greater electrodes can be electrically shorted together, such as the outer electrodes of the illustrated embodiment. In some examples, an electrode can be bent about another electrode such that the bent electrode is on either side of the other electrode. For example, the outer electrodes of the illustrated embodiment of FIG. 2 can comprise a single electrode. By electrically shorting electrodes and/or bending an electrode, the number and area of surfaces able to perform electrolysis can be increased while maintaining two electrical connections (e.g., an anode and a cathode).

The electrodes 106 of the cartridge 104 include at least one anode and cathode and can be made of various metals (e.g., titanium, niobium) and/or metal alloys. The metals are preferably non-corrosive but need not be. In some examples, the electrodes 106 are coated with one or more coatings. The coatings may help prevent degradation of the electrodes 106 and can include, for example, platinum and/or mixed metal oxides. The plurality of the electrodes 106 extend into the bottom portion 112 with two of the electrodes 106 extending through the bottom portion 112. As any number of electrodes greater than two can be used, in some examples, more than two electrodes extend through the bottom portion 112. The electrodes extending through the bottom portion 112 of the cartridge 104 are used to electrically connect to the housing 102 in order to receive power from the housing 102. Additionally, in some examples, the electrodes extending through the bottom portion 112 of the cartridge 104 are used to couple the cartridge 104 to the housing 102.

The top portion 110 and the bottom portion 112 of the cartridge 104 can be used in coupling the cartridge 104 to the housing 102. For instance, the top portion 110 can be sized to extend around and engage (e.g., via a frictional fit) a top of the housing 102. Alternatively, the top portion 110 can be sized to fit within and engage (e.g., via a frictional fit) a top of the housing 102. In addition to or in lieu of engagement between the top portion 110 and the top of the housing 102, the bottom portion 112 can engage the housing 102 to help couple the cartridge 104 to the housing 102. For instance, the housing 102 can include a mounting bracket 114 that engages (e.g., via a frictional fit) the bottom portion 112 of the cartridge. In some examples, such as in the illustrated example of FIG. 1B, the bottom portion 112 defines a keyed hole 116 that can be used to align the cartridge 104 with the housing 102 to ensure a proper connection of the cartridge 104 with the housing 102. In some examples, the housing 102 can include a corresponding projection that engages with the keyed hole 116 to align the cartridge 104 with the housing 102.

To provide power to the plurality of electrodes 106 of the cartridge 104 from the housing 102, the housing 102 includes a wet connection to the plurality of electrodes 106 of the cartridge 104. The wet connection includes a plurality of electrode terminals 120 that are part of the housing 102. The number of electrode terminals can correspond with the number of electrodes that extend through the bottom portion 112 of the cartridge 104. Though in some examples, such as in the illustrated embodiment, the housing 102 includes two electrode terminals 120 that can electrically connect with the two electrodes that extend through the bottom portion 112 of the cartridge 104. The cartridge 104 can be coupled to the housing 102 to electrically connect the electrodes 106 with the corresponding electrode terminals 120. In some examples, the electrode terminals 120 can be biased to frictionally engage the corresponding electrodes 106 and can help prevent the electrodes 106 and the cartridge 104 from being removed from the housing 102. In the illustrated example, as the housing 102 is submersed in water, when the cartridge 104 is coupled to the housing 102, both the electrodes 106 and the electrode terminals 120 are also submerged in water and electrically connect with each other (e.g., a wet connection). However, as the cartridge 104 can be removed and replaced, there may be times during which the electrode terminals 120 are powered. To prevent any current and/or power shortage happening (e.g., unintentional electrolysis) between the electrode terminals 120, the housing 102 can include a spacer 118. In FIG. 2, the spacer extends above a top of the electrode terminals and is as wide or wider than a width of the electrode terminals.

Continuing with the electrode terminals 120 of the housing 102, the electrode terminals 120 extend through the housing base 108. In some examples, the electrode terminals 120 can have gaskets, seals, coatings, or other water-resistant mechanisms at the point where the electrode terminals 120 enter the housing base 108 to prevent water from entering the housing base 108. Further, the electrode terminals 120 can connect to a socket 122 which is configured to receive a cable 124 (e.g., power cable). The socket 122 can be further configured to prevent water from entering the housing base 108 by including gaskets, seals, coatings, or other water-resistant mechanisms. In some examples, the socket 122 prevents water from entering the housing base 108 after the cable 124 is inserted into the socket 122. As both the electrode terminals 120 and the socket 122 include water-resistant mechanisms, the housing base 108 can be watertight and enable dry connections for the components within it. While the socket 122 is illustrated as a female connection and the cable 124 is illustrated as a male connection, the type of connection can be reversed (e.g., male socket and female cable connector).

In accordance with the electrical connections described herein, power from a power source can be provided to the plurality of electrodes 106 of the cartridge 104 for the plurality of electrodes 106 to perform electrolysis. In some examples, an energy storage device (e.g., battery) can be used as a power source for providing power to the plurality of electrodes 106. In the illustrated example, the cable 124 is connected to a power source at one end and connected to the socket 122 of the housing at the other end. Power from the power source can then be transmitted over the cable 124 to the electrode terminals 120. Power can further be transmitted to the plurality of electrodes 106 via the wet connection between the electrode terminals 120 and the plurality of electrodes.

In the embodiment of FIG. 1A/B and FIG. 2, the water sanitation system 100 has certain advantages. For instance, when the plurality of electrodes 106 of a cartridge degrade, the cartridge 104 can be easily removed and replaced with a new cartridge having new electrodes. Further, because the water sanitation system 100 uses a wet connection between the cartridge 104 and the housing 102, only the cartridge 104 needs to be replaced rather than the entire water sanitation system 100. Thus, the configuration can reduce waste.

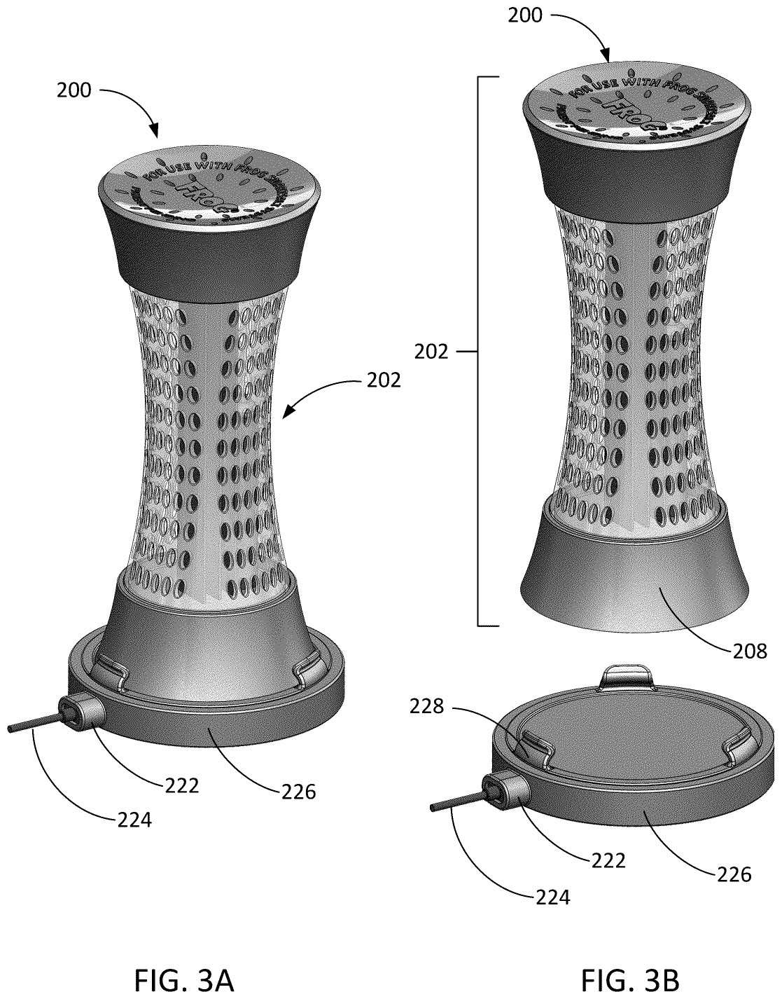

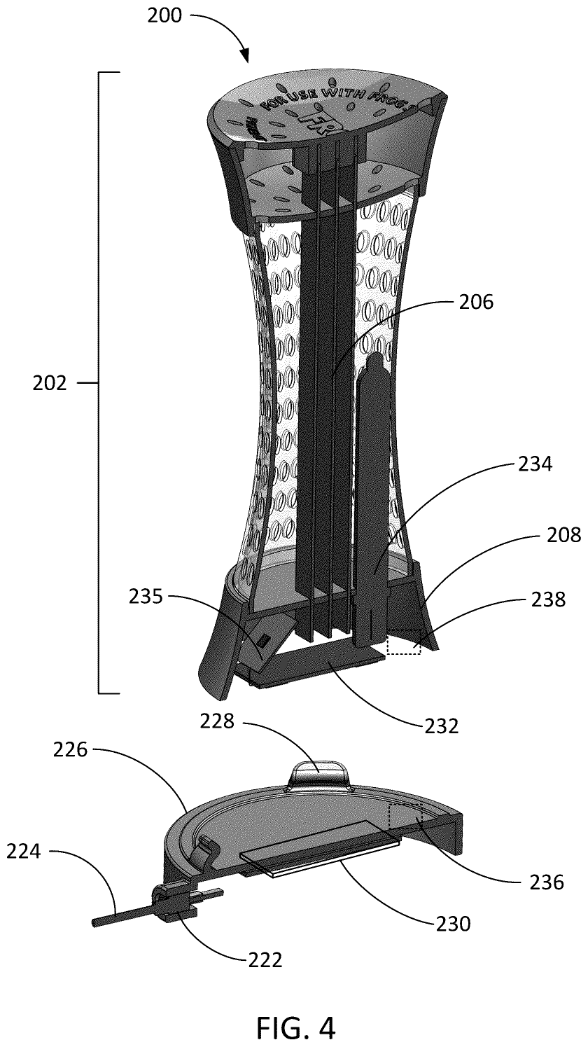

Moving to FIG. 3A, FIG. 3B, and FIG. 4, FIG. 3A and FIG. 3B are perspective views of an alternate example water sanitation system 200 and FIG. 4 is a perspective sectional view of the example water sanitation system 200 of FIG. 3A/B according to an aspect of the present disclosure. The water sanitation system 200 of FIG. 3A/B and FIG. 4 operates in a similar manner as the water sanitation system 100 of FIG. 1A/B and FIG. 2 in that when it is submerged in saltwater, the water sanitation system 200 is configured to generate oxidizing agents (e.g., chlorine, bromine) via electrolysis of the saltwater. The water sanitation system 200 includes electrodes 206 that in some examples, are configured to perform electrolysis of the saltwater and generate chlorine when they are powered. However, various physical and electrical connections of the water sanitation system 200 of FIG. 3A/B and FIG. 4 are different than the physical and electrical connections of the water sanitation system 100 of FIG. 1A/B and FIG. 2.

The water sanitation system 200 of FIG. 3A/B and FIG. 4 includes a housing 202 removably couplable to a base 226. In the illustrated embodiment, to connect the housing 202 to the base 226, the base 226 includes connection clips 228 that can engage a bottom of the housing 202 (e.g., housing base 208). Any number of clips can be used. In some examples, the reverse of the illustrated connection is used whereby the housing 202 includes one or more clips with the base 226 configured to be clipped to. A person having ordinary skill in the art will appreciate that any mechanism that enables the housing 202 to removably couple to the base 226 can be used and that this disclosure is not limited to the illustrated clip mechanism. For instance, in some examples, the housing can be removably couplable to the base using magnets, fasteners, twist and lock mechanisms, frictional engagement mechanisms, and/or others.

While the water sanitation system 100 of FIG. 1A/B and FIG. 2 includes a wet electrical connection including electrodes connected to electrode terminals, the water sanitation system 200 of FIG. 3A/B and FIG. 4 does not include a wet electrical connection between the housing 202 and the base 226. Instead, the base 226 can electrically connect to the housing 202 wirelessly. In particular, the housing 202 can receive power wirelessly from the base 226. For instance, in the illustrated example, the base 226 includes a base induction element 230 (e.g., induction coil) and the housing 202 includes a housing induction element 232 (e.g., induction coil). Accordingly, when the housing induction element 232 is brought in close proximity to the base induction element 230, such as when the housing 202 is coupled to the base 226, the base induction element 230 can transmit power wirelessly to the housing induction element 232. While induction elements using inductive coupling are used in the illustrated embodiment, other mechanisms of wireless power transfer are contemplated, and this disclosure is not limited to using inductive coupling.

The housing induction element 232 is electrically connected to a plurality of electrodes 206 and can provide power to the plurality of electrodes 206. In the illustrated example of FIG. 4, to electrically connect the housing induction element 232 with the plurality of electrodes 206, the water sanitation system 200 includes electronics 235. In some examples, the electronics 235 can include power electronics (e.g., power converter) that can convert electrical energy received by the housing induction element 232 into a form usable by the plurality of electrodes 206. In some examples, the electronics 235 can control an electrical output of the electrodes 206.

As with the example water sanitation system 100 of FIG. 1A/B and FIG. 2, the plurality of electrodes 206 are configured to perform electrolysis on the surrounding water when they are powered. Because the surrounding water is saltwater, the plurality of electrodes 206 can generate oxidizing agents such as halogens using electrolysis.

As best seen in the illustrated embodiment of FIG. 4, two or more of the plurality of electrodes 206 can secure to, and extend through, the housing base 208 to electrically connect to the housing induction element 232. The plurality of electrodes 206 include at least one anode and at least one cathode with at least one anode and one cathode electrically connected to the housing induction element 232 to receive power. Further electrodes can be connected (e.g., in parallel) to the one anode and the one cathode to receive power. The electrodes that extend into the housing base 208 can include water-resistant mechanisms (e.g., seals, gaskets, etc.) at the point where the electrodes entire the housing base 208. These water-resistant mechanisms can prevent water from entering the housing base 208 and accordingly, the housing base 208 can be watertight.

In similarity with the water sanitation system 100 of FIG. 1A/B, the base 226 can include a socket 222 configured to receive a cable 224. The cable 224 can be connected to a power source such as, for example, a spa control panel. The socket 222 can also be configured with water-resistant connection mechanisms (e.g., seals, gaskets, etc.) to prevent water from entering the base 226 through the socket 222. In some examples, by including water-resistant connection mechanisms such as for the socket 222, the base 226 can be watertight. In some examples, though, a portion of the base 226 can be located behind a wall of a spa/pool. In such examples, a water-resistant connection can be made between the base 226 and the wall. In an example, the portion of the base 226 that includes the socket 222 can be located behind a spa wall and can prevent the socket 222 from being exposed to water in the spa.

Referring to the electrical connections of the water sanitation system 200 of FIG. 3A/B and FIG. 4, power from a power source can be transmitted via wired connection through the cable 224 to the base induction element 230. Power can then be transmitted wirelessly from the base induction element 230 to the housing induction element 232 when the housing 202 is coupled with the base 226. Power can then be transmitted from the housing induction element 232 to the plurality of electrodes 206. Thus, the plurality of electrodes 206 can receive power from the power source and use the power to generate oxidizing agents (e.g., chlorine) via electrolysis. In some examples, the housing induction element 232 can be connected to other components within the housing 202 and can provide power to such components.

The water sanitation system 200 can also include a water monitoring sensor 234 configured to monitor one or more properties of the water. As seen in the illustrated embodiment of FIG. 4, the water monitoring sensor 234 can be partially located within the housing base 208 and partially located outside the housing base 208. In such an embodiment, the water monitoring sensor 234 can include a gasket to prevent water from entering the housing base 208. The water monitor sensor 234, though, can be located anywhere so long as it is able to sample fluid. In some examples, the water monitoring sensor 234 measures a halogen (e.g., chlorine, bromine) concentration in the water. In some such examples, the water monitoring sensor 234 indirectly measures the concentration of the halogen(s), such that it provides an indication of the concentration of the halogen(s). Additionally or alternatively, the water monitoring sensor 234 can measure total dissolved solids (TDS), a conductivity, an oxidation reduction potential (ORP), a PH, and/or a temperature of the water. In some examples, the water monitoring sensor 234 is an amperometric sensor. While only one water monitoring sensor 234 is illustrated, the water sanitation system 200 can include multiple water monitoring sensors that may measure one or more properties of the water.

In some examples, the water monitoring sensor 234 receives power wirelessly via the housing induction element 232 and the base induction element 230. In some such examples, the water monitoring sensor 234 and any associated circuity (e.g., electronics 235) can be powered separately from the plurality of electrodes 206. For instance, the housing induction element 232, the base induction element 230, and any associated electronics can be configured to selectively provide power to the water monitoring sensor 234 and the plurality of electrodes, such that one, the other, or both are powered wirelessly (e.g., via housing base 208). In some examples, a first power source can power electrodes while a second power source powers the water monitoring sensor.

Alternatively, in some examples, the water monitoring sensor 234 can receive power wirelessly via induction elements separate from the housing induction element 232 and the base induction element 230. By receiving power wirelessly, the water monitoring sensor 234 can help enable a non-wet connection between the housing base 208 and the housing 202. In some examples, to monitor the water, the water monitoring sensor 234 includes a port/inlet that is in fluid communication with the water. The water monitoring sensor can be located within the housing base 208 and in such cases, a port/inlet can include water-resistant connection mechanisms to prevent water from leaking around the port/inlet and into the housing base 208.

In some examples, the water monitoring sensor 234 can wirelessly receive and transmit measurement data, such as with an external device (e.g., spa controls). The wireless receiving and transmitting of signals can be performed using any wireless protocol. In some examples, near field communication (NFC) is used between a water monitoring sensor and the external device. Such an NFC connection can be used to provide power and/or data to the water monitoring sensor 234. In some examples, the NFC connection can use NFC antennas for providing wireless power and/or data to and/or from the water monitoring sensor 234. In some examples, though, the NFC can use the housing induction element 232 and the base induction element 230 for providing wireless power and/or data to and/or from the water monitoring sensor 234.

In one example operation, the water monitoring sensor 234 can receive and transmit data via the wireless connection between the housing 202 and the base 226. The water monitoring sensor 234 can transmit data to an NFC antenna or the housing induction element 232, which can wirelessly transmit the data to a corresponding NFC antenna in the base, or transmit the data to the base induction element 230. From the base 226, the data can be transmitted via wired or wireless connection to an external device (e.g., spa controls). Similarly, the external device can transmit data to the base 226 and to the water monitoring sensor 234 via the NFC antennas or via the base induction element 230 and the housing induction element 232. In some examples, data is transmitted from the NFC antenna in the base to the NFC antenna in the housing using a first protocol (e.g., frequency modulated (FM) protocol, amplitude modulated (AM) protocol) and data is transmitted from the NFC antenna in the housing to the NFC antenna in the base using a second protocol. In some examples, data is transmitted from the base induction element 230 to the housing induction element 232 using a first protocol and data is transmitted from the housing induction element 232 to the base induction element 230 using a second protocol.

The wireless connection between the housing 202 and the base 226 can transmit data in both directions and can also transmit power. In some examples, the water monitoring sensor 234 can transmit data via a wireless connection (e.g., induction elements) that is separate from the wireless connection for power (e.g., housing induction element 232 and the base induction element 230). For example, the housing 202 can include a second housing induction element and the base can include a second base induction element with the second housing induction element and the second base induction element configured to transmit data wirelessly therebetween.

In some examples, a first set of induction elements comprising a first base induction element and a first housing induction element are structured and/or oriented in a first manner, while a second set of induction elements comprising a second base induction element and a second housing induction element are structured and/or oriented in a second manner. For instance, the first set of induction elements can be used for wireless power, and/or communication, for a plurality of electrodes while the second set of induction elements can be used for wireless power and/or communication for a water monitoring sensor. In an example, the first set of induction elements can be oriented to enable wireless power and/or communication in a Z axis, while the second set of induction elements can be oriented to enable wireless power and/or communication in an X or Y axis.

In addition to or in lieu of the wireless connection between the housing 202 and the base, in some examples, the water monitoring sensor 234 can include, or be connected to, a wireless transmitter that can wirelessly transmit data through water surrounding the water sanitation system 200. The data can then be received wirelessly at the external device (e.g., spa controls).

While described as being co-located with the plurality of electrodes 206 and as part of the water sanitation system 200, the water monitoring sensor 234 can be independent from the water sanitation system 200. In the examples where the water monitoring sensor 234 is independent, the water monitoring sensor 234 can be powered using a wireless connection (e.g., via induction elements). The wireless connection can also be used to send and/or receive data (e.g., to/from a spa controller).

In some examples, the water sanitation system 200 includes an identification chip reader 236 located in the base 226. The identification chip reader 236 can interface with a corresponding identification chip 238 located within the housing 202 (e.g., via wireless communication) and can read data from the identification chip 238. The identification chip 238 itself can be powered (e.g., via the housing induction element 232) or unpowered. The identification chip reader 236 can be in wired or wireless communication with an external device (e.g., spa/pool controls) and can send/receive power and/or data from the external device. For instance, the identification chip reader 236 can read data from the identification chip 238 and report the data to the external device. In such an example, the external device can determine if the data read from the identification chip 238 is acceptable. The identification chip 238 can store data that is used to ensure the housing 202 and the components therein are compatible with the base 226 and components connected to the base (e.g., spa/pool controls). For example, the identification chip reader 236 can interface with the corresponding identification chip 238 and report to the external device that the housing 202 and the components inside, such as the water monitoring sensor 234, will work with the base 226 and the components connected thereto (e.g., spa/pool controls). In some examples, the identification chip 238 can store other data such as a total runtime of the components (e.g., electrodes 206) of the housing 202. Such data can also be transmitted to an external device. By including an identification chip 238 and corresponding identification chip reader 236, a spa system can differentiate between a housing having a water monitoring sensor that works with the spa system and a housing with a water monitoring sensor that does not work with the spa system. Additionally, a spa system can determine an amount of runtime of components of the water sanitation system to determine when the water sanitation system requires replacement.

In the embodiment of FIG. 3A/B and FIG. 4, the water sanitation system 200 has a housing 202 that includes the plurality of electrodes 206 and a base 226 with wireless power transmission occurring between the base 226 and the housing 202. This configuration has certain advantages. For instance, because of the wireless transmission of power between the base 226 and the housing 202, no wet connection is needed. Instead, the socket 222 and cable 224 of the base can be connected behind a wall (e.g., sidewall of a spa) in a dry location with power transmitted wirelessly from the base 226 to the housing 202 via the induction elements 230, 232. Avoiding a wet connection can be beneficial as wet connections can break down (e.g., short) and/or cause leaks. Additionally, the housing 202, which includes the plurality of electrodes 206, can be easily replaced due to the removable coupling (e.g., connection clips 228) between the housing 202 and the base 226.

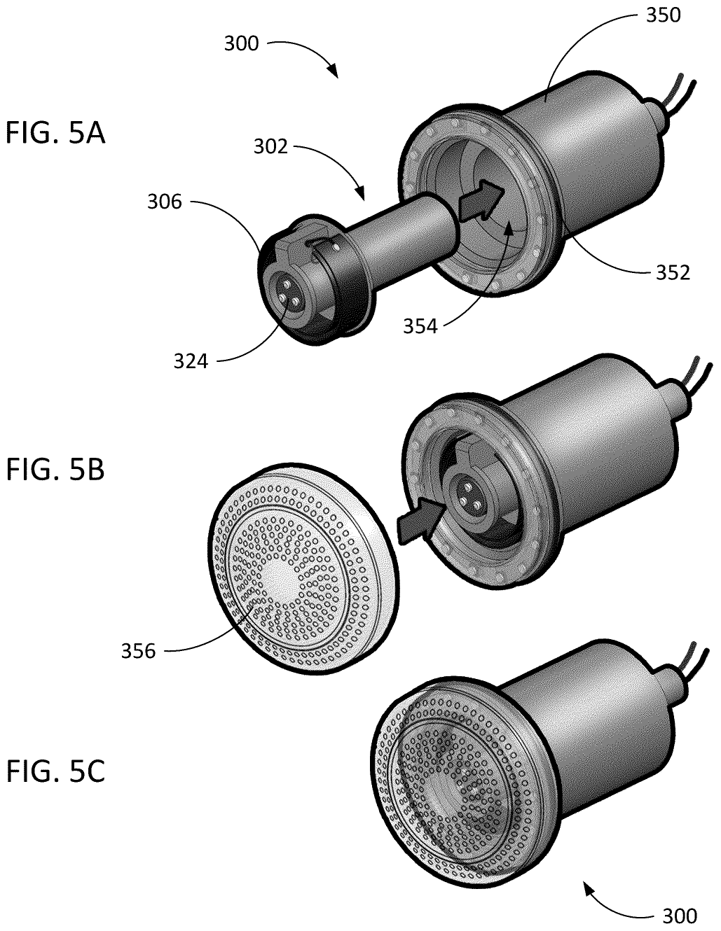

Moving to FIG. 5A-C, FIG. 5A-C are perspective views of an alternate example water sanitation system 300 according to an aspect of the present disclosure. The water sanitation system 300 operates in a manner comparable to the water sanitation systems described elsewhere herein in that, when submerged in saltwater, the water sanitation system 300 is configured to generate oxidizing agents (e.g., chlorine, bromine) via electrolysis. However, in comparison to the other water sanitation systems described herein, the water sanitation system 300 of FIG. 5A-C is configured to be recessed within, for example, a spa/pool wall. For instance, in some examples, the water sanitation system 300 of FIG. 5A-C can be retrofit to an existing pool/spa.

The water sanitation system 300 includes a housing base 350 that defines a receptacle 354 into which a housing 302 is inserted, as indicated by the arrow. The housing base 350 can take many forms and can be coupled to the housing 302 in a variety of ways. For instance, the housing base 350 can include threads for the housing 302 to screw into, can include one or more clips and/or corresponding recesses, can include twisting locks, can include a frictional fit, and/or other coupling mechanisms. The housing base 350 need not be directly coupled with the housing 302 though. For example, the water sanitation system 300 includes a diffuser 356 that can be coupled to the housing base 350 (e.g., via a snap-on fit) and which can maintain the housing 302 within the receptacle 354 of the housing base 350. A person having ordinary skill in the art will appreciate that other types of couplings between the housing base 350, the housing 302, and/or the diffuser 356 are contemplated and that this disclosure is not limited to any specific type of coupling.

As with other water sanitation systems disclosed herein, the housing 302, which can also be referred to as a cartridge, includes a plurality of electrodes 306 that are used to perform electrolysis and generate oxidizing agents. In the illustrated embodiment, the plurality of electrodes 306 include two circular-shaped electrodes spaced apart from each other and electrically connected within the housing 302. When the housing 302 is coupled with the housing base 350, the plurality of electrodes 306 can be electrically connected with the housing base 350 and can receive power through the electrical connection. In some examples, the electrical connection between the housing 302 and the housing base 350 comprises a wet connection, such as is described elsewhere herein. In some such examples, to enable the wet connection, the housing 302 and the housing base 350 can each include one or more electrodes, contactors, pins, wires, electrode terminals, receptacles, and the like which can interface with each other to electrically connect components of the housing 302 (e.g., electrodes 306) with components of the housing base 350 (e.g., wires to an external device/power). Additionally or alternatively, in some examples, the electrical connection between the housing 302 and the housing base 350 comprises a wireless electrical connection, such as is described elsewhere herein. In some such examples, to enable the wireless connection, the housing 302 and the housing base 350 can each include one or more induction elements which can wirelessly transmit power and/or data.

Continuing with the example of FIG. 5A-C, the housing 302 also includes a water monitoring sensor 324 that can be configured in a comparable manner as the water monitoring sensor 234 described with respect to FIG. 4 to measure one or more water properties (e.g., temperature) and/or indications of the one or more water properties (e.g., chlorine concentration). The water monitoring sensor 324 is located centrally within the housing 302 with a portion that samples water exposed to the water proximate the diffuser 356. The water monitoring sensor 324, in similarity with the electrodes 306, can receive power through the electrical connection between the housing 302 and the housing base 350. Again, the electrical connection can include a wet connection (e.g., wired connection) and/or a wireless connection. In some examples, the water monitoring sensor 324 can transmit/receive data through the wet connection and/or the wireless connection with the housing base 350 and in some examples, can transmit/receive data wirelessly without the wireless connection.

The illustrated water sanitation system 300 of FIG. 5A-C can have advantages over the water sanitation systems illustrated elsewhere herein. For example, as the housing base 350 is configured to be primarily located behind a wall of a spa/pool with a gasket 352 separating the portion to be located behind the wall and the portion to be located within the spa/pool, the water sanitation system can be unobtrusive. Further, such a configuration of the water sanitation system 300 can enable the system to be retrofit into an existing spa/pool, such as by replacing a housing used for lighting or for a water jet. As with the other water sanitation systems descried herein, the water sanitation system 300 can also enable a user to easily replace the plurality of electrodes 306 as they wear.

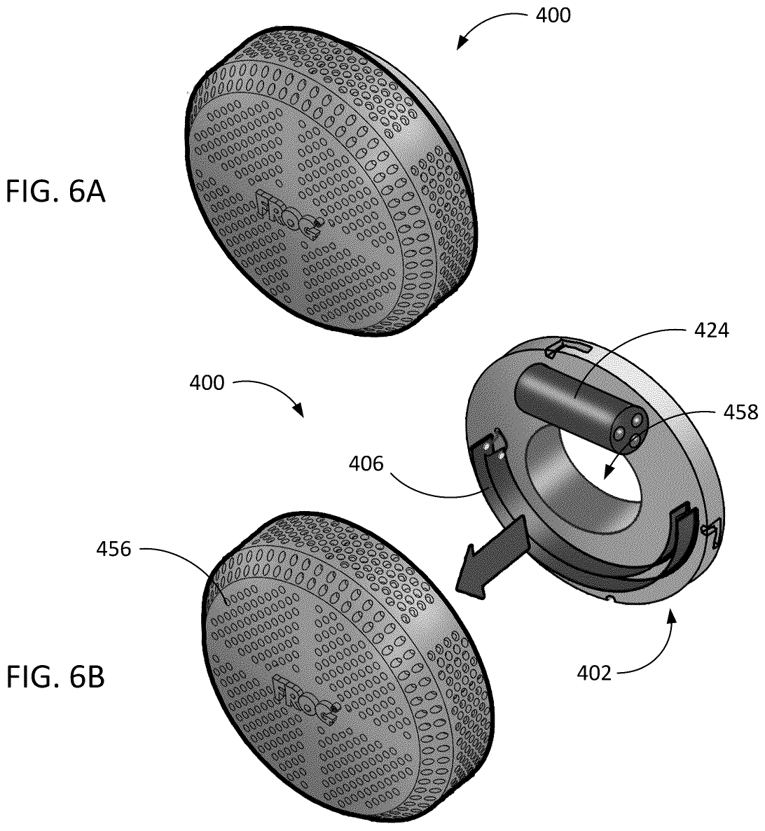

Moving to FIG. 6A-B, FIG. 6A-B are perspective views of an alternate example water sanitation system 400 according to an aspect of the present disclosure. The water sanitation system 400 operates in a comparable manner as the water sanitation systems described elsewhere herein in that when submerged in saltwater, the water sanitation system 400 is configured to generate oxidizing agents (e.g., chlorine, bromine) via electrolysis. However, the water sanitation system 400 differs from the other water sanitation systems described herein in its physical form. In particular, the water sanitation system 400 defines a hole 458 through which water can flow. For example, the hole 458 can accommodate a suction port or water jet. By accommodating a suction port and/or water jet, the water sanitation system 400 can advantageously disburse oxidizing agents which it generates (e.g., into the spa/pool and/or into the filtering system). The water sanitation system 400 also includes a diffuser/filter 456. The diffuser/filter 456 can help diffuse water and oxidizing agents through a spa/pool and/or prevent debris or other objects from being sucked in. The diffuser/filter 456 can be secured to the housing 402 via one or more twisting locks, for example.

The water sanitation system 400 includes a plurality of electrodes 406 and a water monitoring sensor 424 that are located on a housing 402. While not specifically illustrated, the housing 402 can be coupled to a base to which it is further electrically connected. As with other water sanitation systems described herein, the electrical connection between the housing 402 and the base can be a wet connection (e.g., a wired connection) and/or a wireless connection. Through such a connection, the electrodes 406 and the water monitoring sensor 424 can receive power and in some examples, the water monitoring sensor, can also provide data through such a connection.

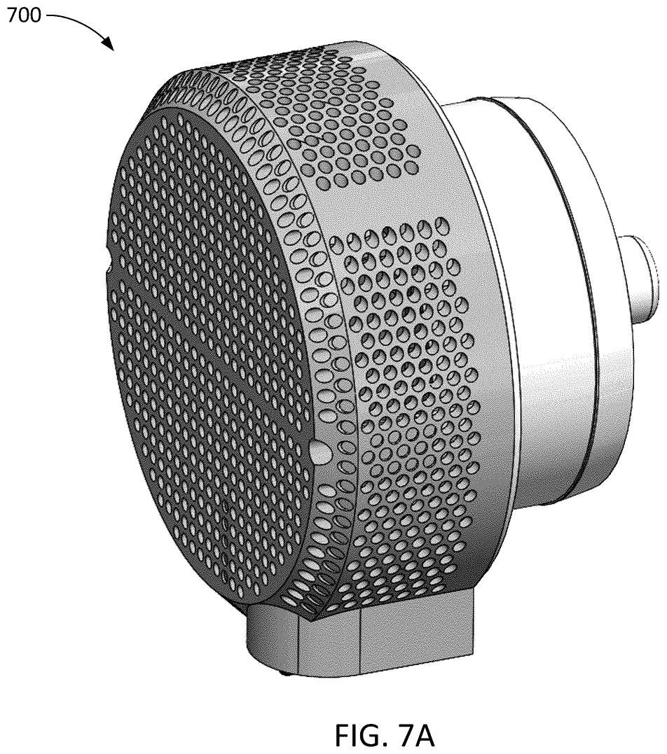

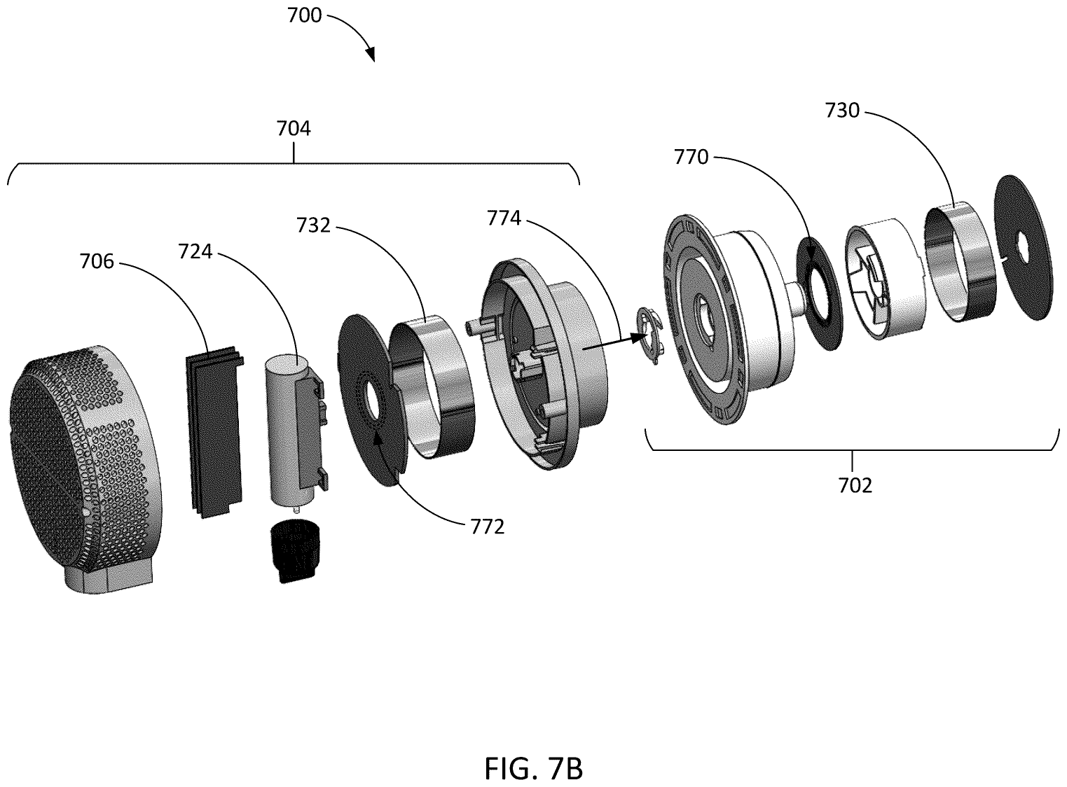

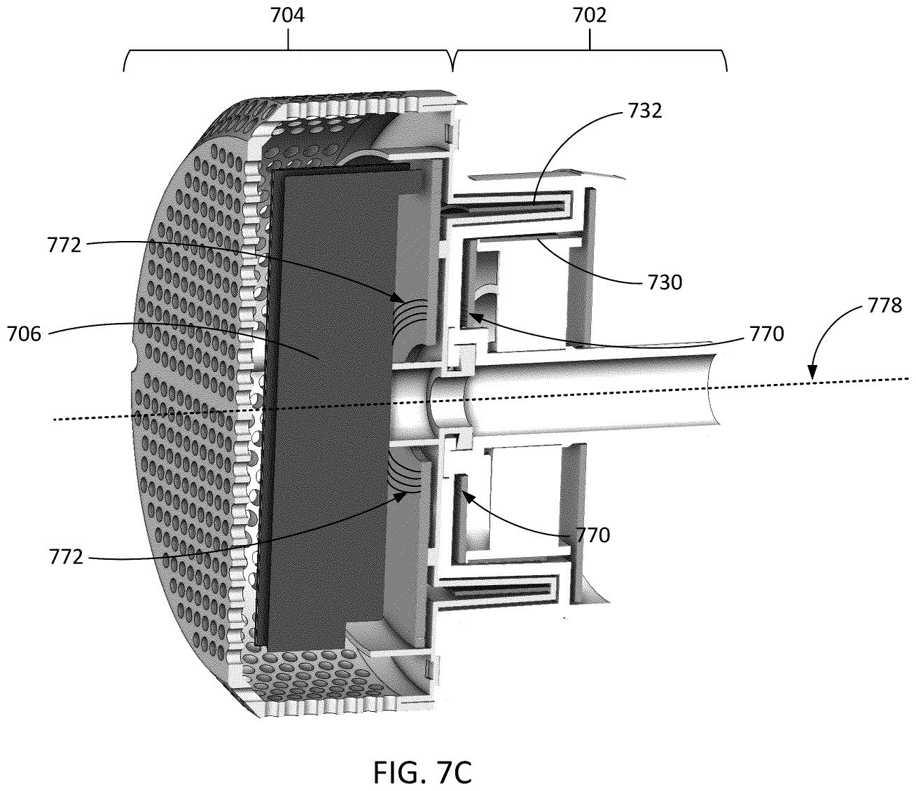

Referring to FIG. 7A-7C, FIG. 7A-7C are perspective views of an alternate example water sanitation system 700 according to an aspect of the present disclosure. The water sanitation system 700 includes a housing 702 and a cartridge 704. The housing 702 can be a permanent fixture while the cartridge 704 is a replaceable fixture. For example, the housing 702 can be integrated into the design of a new spa, or be retrofit into an existing spa, while the cartridge 704 is replaceable. An advantage of the cartridge being replaceable is that the cartridge 704 includes electrodes 706, which can degrade over time as they are used to generate halogens (e.g., chlorine, bromine). Instead of replacing the entire system 700, a user may only need to replace the cartridge 704 when the electrodes 706 are no longer useful.

While the water sanitation system 700 of FIG. 7A-7C is similar to the other water sanitation systems described herein, the water sanitation system 700 of FIG. 7A-7C includes separate wireless power transfer and wireless communication. Using wireless power transfer and wireless communication, the water sanitation system 700 does not need to include a connection (e.g., a wet connection) that may degrade over time. This can increase the reliability of the system 700 and extend its operating life.

The wireless power transfer is enabled by the use of the housing induction element 730 and the cartridge induction element 732. These induction elements 730, 732 are configured as coils, as illustrated in FIG. 7B. However, the induction elements 730, 732 can be of other suitable geometries. When energized and placed proximate to each other, as in FIG. 7C, the induction elements 730, 732 can transfer power between them. For example, the housing induction element 730 can generate an alternating electromagnetic field that is received by the cartridge induction element 732, which then induces a current in the cartridge induction element 732 through the principle of electromagnetic induction. The housing induction element 730, which in operation is electrically connected to a power source (e.g., spa power source, external power source), can thus provide power wirelessly to the cartridge induction element 732. As the cartridge induction element can be electrically connected to various components of the cartridge 704 (e.g., electrodes 706, water monitoring sensor 724), power is wirelessly transferred from a power source external to the cartridge 704 to the cartridge 704. The use of wireless power transfer can not only enhance the reliability and longevity of the water sanitation system by eliminating physical electrical connections (both wet and dry connections) but can facilitate easy replacement and maintenance of the cartridge 704.

In some examples, the induction elements 730, 732 can be designed to have various shapes (e.g., circular, rectangular, spiral, oval, planar coils) and placements within the system 700. Certain configurations of the induction elements can optimize coupling efficiency and accommodate different spatial constraints within the housing and cartridge. For example, in the illustrated example of FIG. 7B, the housing induction element 730 and the cartridge induction element 732 take the form of a cylindrical shell having a width and defining a large opening. One of the housing induction element 730 or the cartridge induction element 732 has a smaller diameter than the other. As best seen in FIG. 7C, the housing induction element 730 has a smaller diameter than the cartridge induction element 732. This enables the cartridge induction element 732 to surround the housing induction element 730, or in other words, the housing induction element 730 is coaxial to (e.g., radially inward of relative to central axis 778) the cartridge induction element 730. However, the width of both induction elements 730, 732 enables power sharing between the two. It can be advantageous to minimize the radial distance (e.g., from the central axis 778) between the induction elements 730, 732 to maximize the efficiency of power transfer.

Continuing with FIG. 7A-7C, wireless communication between the housing 702 and the cartridge 704 can be enabled by the use of a housing near-field communication (NFC) antenna 770 and a corresponding cartridge NFC antenna 772. These antennas are positioned such that, when the cartridge 704 is installed within the housing 702 as shown in FIG. 7C, they are in close proximity, allowing for efficient near-field coupling. The NFC antennas 770, 772 are configured to transmit and receive electromagnetic signals with a higher frequency than the induction elements 730, 732. The higher frequency can enable more efficient and faster communications, enabling data transfer rather than only power transfer.

Through the wireless communication link enabled by the NFC antennas 770, 772, a variety of signals can be sent and received. For example, the cartridge 704 can include the water monitoring sensor 724, which measure properties such as chlorine concentration, pH, temperature, oxidation-reduction potential (ORP), conductivity, or total dissolved solids (TDS). The data collected by the water monitoring sensor 724 can be transmitted from the cartridge 702 to the housing 704 via the cartridge NFC antenna 772 to the housing NFC antenna 770. This data can be further relayed to external control systems (e.g., spa control system), user interfaces, and/or the like for analysis and display.

In addition to water monitoring measurements, the NFC antennas can facilitate the transmission of identification data between the cartridge 704 and the housing 702. This wireless exchange of identification information can enable the system to verify compatibility between the cartridge and the housing, track operational status, and/or monitor the total runtime or usage history of the cartridge components.

In some examples, the NFC antennas 770, 772 can be designed to have various shapes and placements within the system 700 to optimize wireless communication performance and minimize interference with other system components. For instance, the NFC antennas 770, 772 illustrated in FIG. 7C are generally circular in shape and have similar diameters, which facilitates uniform electromagnetic coupling and consistent signal strength across the interface between the housing 702 and the cartridge 704.

The placement and orientation of the NFC antennas 770, 772 can be considered to maximize communication efficiency and prevent cross-talk or interference with other elements of the system 700, including the induction elements 730, 732 used for wireless power transfer. For instance, as shown in FIG. 7C, the NFC antennas 770, 772 are aligned with each other along the central axis 778 (e.g., axially). The alignment along the central axis 778 means that the NFC antennas are oriented at a 90-degree offset relative to the alignment of the induction elements 730, 732. By positioning the NFC antennas 770, 772 and induction elements 730, 732 orthogonally to each other, the system 700 can ensure that the magnetic fields generated for power transfer and data communication do not interfere with one another, thereby maintaining the integrity of both wireless channels.

Additionally, the NFC antennas 770, 772 are located radially inward from the induction elements 730, 732. This spatial separation further reduces the potential for electromagnetic interference. For example, because the communication between the induction elements 730, 732 occurs radially outward from the NFC antennas 770, 772, the electromagnetic fields generated by the induction elements 730, 732 are less likely to interfere with the electromagnetic fields generated by one or both of the NFC antennas 770, 772. Further, as illustrated in FIG. 7C, the NFC antennas 770, 772 are in close proximity to each other with minimal intervening metallic or conductive materials. This proximity enables robust and efficient near-field coupling, which assists in reliable data exchange. In some examples, the system 700 can include shielding and/or selective placement of non-magnetic materials to further enhance communication performance and prevent signal degradation.

As with other antennas, the NFC antennas 770, 772 can take on different shapes with different sizes while still accommodating near-field communications. For example, as illustrated in FIG. 7B and FIG. 7C, the NFC antennas 770, 772 are generally circular in nature, which can enable water circulation within the system 700. However, other configurations of antennas are contemplated.

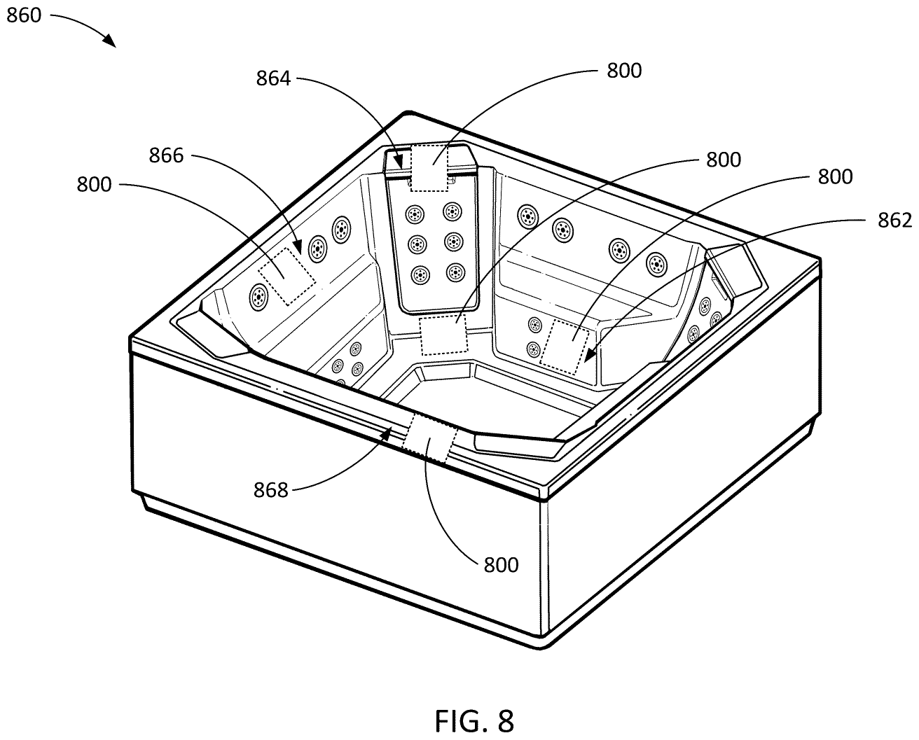

While the example water sanitation systems disclosed herein are illustrated as having certain physical shapes, it will be appreciated that other forms can be used. For instance, while the housing 202 of the water sanitation system 200 described in FIG. 3A/B and FIG. 4 is generally cylindrical, other shapes are contemplated, such as the housing 302 of FIG. 5 and the housing 702 of FIG. 8. In general, water sanitation systems described herein can have any shape/form factor. In some examples, the physical shape/form factor of water sanitation systems described herein is limited by the plurality of electrodes. In some examples, the physical shape/form factor of water sanitation systems described herein is limited by a mounting location in a spa/pool.

Aspects of the various water sanitation systems described herein can also be combined in various configurations. For example, the wet connection described with respect to FIG. 2, which includes the electrodes 106 and the electrode terminals 120, can be used in water sanitation systems that do not use a cartridge. In another example, the water sanitation system 200 of FIG. 3A/B and FIG. 4 can use a cartridge in addition to using wireless power/data transmission. In one such example, the housing 202 can be configured to act like the housing 102 and cartridge 104 of FIG. 2, with the exception that the housing base 208 would be powered via the housing induction element 232 illustrated in FIG. 4 rather than the wired connection illustrated in FIG. 2. In another configuration, a water sanitation system can include a wired/wet connection for providing power to its electrodes but include a wireless connection (e.g., power and/or data) for its water monitoring sensor. The reverse configuration, where the water sanitation system includes a wireless connection for providing power to its electrodes and includes a wired/wet connection for its water monitoring sensor, is also contemplated. In yet another configuration, the housing base 108 illustrated in the example water sanitation system 100 of FIG. 1A/B and FIG. 2 can be coupled to a second base that is configured to provide wireless power to the housing base 108 (e.g., via induction elements in the housing base 108 and the second base). Such a configuration would enable removal of the socket 122 and cable 124 and would further enable replacement of the housing base 108. As a person having ordinary skill in the art will appreciate, various combinations of features of the example water sanitation systems described herein are contemplated and that this disclosure is not limited to the examples provided herein.

The example water sanitation systems disclosed herein can enable a variety of placements of the water sanitation systems in spas/pools that are advantageous. For instance, the example water sanitation system described with respect to FIG. 1A/B and FIG. 2 includes a wet connection between the cartridge 104 and the housing 102. The wet connection and use of a cartridge containing a plurality of electrodes, which eventually require replacement, enables the water sanitation system to be located under a water level of a spa/pool. With a wet connection, rather than a dry connection, a user replacing the cartridge does not need to drain the spa/pool to ensure a dry connection between electrodes and their power source. Accordingly, the water sanitation system can be located well below a water level of the spa/pool.

Further, the example water sanitation systems described with respect to FIG. 3A/B, FIG. 4, and FIG. 7a-c include wireless power transmission between the base and the housing containing a plurality of electrodes. This wireless power transmission also enables the water sanitation systems to be located under the water level of a spa/pool. With the wireless power transmission, a user replacing the housing does not need to drain the spa/pool to ensure a dry connection between electrodes and their power source. Moreover, some of the example water sanitation systems disclosed herein can be separate from a water circulation system for a spa/pool. This is advantageous as the water sanitation systems can run and generate oxidizing agents when a circulation system is not running, thereby saving energy.

Referring to FIG. 8, FIG. 8 is a perspective view of a spa 860 including various possible placements of a water sanitation system 800 according to aspects of the present disclosure. While embodiments of the water sanitation system described herein are not restricted to any particular location in a spa/pool, FIG. 8 illustrates a variety of possible placements for a water sanitation system within a spa 860.

For example, a first placement of a water sanitation system 800 can be in or proximate a spa well 862. The spa well 862 is located proximate a bottom of the spa 860. Locating the water sanitation system 800 in the spa well 862 can be advantageous as in many spas, a pump and/or a suction port (e.g., for a pump/pumps) is also located in the spa well 862. The pump can circulate water in the spa and the suction port can pull water from the spa well to be disbursed elsewhere (e.g., into a filtering system or out of a jet). Accordingly, oxidizing agents generated by the water sanitation system 800 can also be circulated throughout the spa 860 via mixing with the water circulated by the pump and/or by the suction port. Further, locating the water sanitation system 800 in the spa well 862 can make the water sanitation system 800 relatively unobtrusive to users of the spa 860.

A second placement of a water sanitation system 800 can be in, proximate, or below a filter well 864. While the filter well 864 is illustrated as being located behind jets, the filter well 864 can be located separate from jets (e.g., in its own dedicated area). Filter wells can be located proximate a water level of a spa. Accordingly, the water sanitation system 800 can similarly be located proximate the water level of the spa. However, in some examples, filter wells are located in other areas of a spa (e.g., well below the water level). In some examples, a permanent fluid connection (e.g., fitting) can be located in, proximate, or below the filter well such that a water sanitation system can couple to the permanent fluid connection. Such a permanent fluid connection can comprise fittings, tubes, and other fluid connection components. In some such examples, the water sanitation system can be replaced (e.g., at regular intervals) by coupling a new water sanitation system to the spa's overall fluid distribution system at the permanent fluid connection.

Locating the water sanitation system 800 in, proximate, or below the filter well 864 can be advantageous as the location is unobtrusive and the water sanitation system 800 is then co-located with other filtering/cleaning elements used to keep the spa sanitary/clean. Water movement proximate the filter well 864 can also be increased relative to other areas of the spa 860 and can increase disbursement of oxidizing agents generated by the water sanitation system 800.

A third placement of a water sanitation system 800 can be in or proximate a sidewall 866 of the spa 860. Locating the water sanitation system 800 in or proximate a sidewall of the spa 860 can be advantageous as the sidewalls can include jets that can increase disbursement of oxidizing agents generated by the water sanitation system 800. In some examples, the water sanitation system 800 can be recessed (e.g., in the sidewall 866) such that the water sanitation system does not significantly protrude into the volume of the spa (e.g., places where users of the spa will sit). In such examples, water still surrounds the plurality of electrodes of the water sanitation system to enable generation of oxidizing agents.

A fourth placement of a water sanitation system 800 can be in or proximate a spa rail 868. Locating the water sanitation system 800 in or proximate a spa rail of the spa 860 can be advantageous as the location can unobtrusive. Further, locating the water sanitation system 800 in or proximate a spa rail can enable a user to easily replace fouled electrodes, as described elsewhere herein, due to the proximity to the exterior of the spa. In some embodiments, the electrodes of the water sanitation system are located directly in the water of the spa while in some embodiments, a pump can pump water through the electrodes of the water sanitation system such that the water sanitation system does not need to be submerged in water to operate.

A fifth placement of a water sanitation system 800 can be in or proximate a light recess and/or water jet. The light recess and/or water jet can be located in a variety of locations, such as located in the spa well 862, for example. Locating the water sanitation system within a light recess and/or water jet can be advantageous as the water sanitation system can be retrofitted into a pool/spa that was not specifically designed to work with the water sanitation system. Accordingly, electrical connections for the water sanitation system, such as those that connect a base (e.g., housing base 350) to an external device and/or power supply, can be easily made by utilizing the existing electrical connections for the light and/or water jet.

In addition to the various placements of a water sanitation system illustrated in FIG. 8, in some examples, embodiments of the water sanitation systems described herein can have portions that are located behind a wall of a spa/pool (e.g., not exposed to water of the spa/pool). Including portions of a water sanitation system behind a wall of a spa/pool can be advantageous as those portions do not need to be configured to be water resistant. In some examples, some or all of a base (e.g., housing base 350) can be located behind a wall of a spa/pool. Such configurations can also be advantageous as the base can provide power through the wall of the spa/pool without all of the base being directly exposed to water within the spa/pool.

In some embodiments, the water sanitation system (e.g., 800) can be preinstalled in a spa during manufacturing, rather than installed by an end-user. The water sanitation system can be preinstalled in any location, such as any of the locations illustrated in the example of FIG. 8. Preinstalling the water sanitation system can be beneficial as the water sanitation system can be more easily integrated with the spa's electrical and plumbing systems and can allow for immediate use by the end user without requiring aftermarket installation. This approach can also facilitate easier maintenance and replacement of components, as the system is designed to be accessible and compatible with the spa's structure from the outset, rather than retrofitting the water sanitation system into an existing spa.

While some preferred embodiments have been described, it should be understood that various changes, adaptations, and modifications may be made therein without departing from the spirit of the disclosure and the scope of the following enumerated embodiments.

1. A water sanitation system for use in saltwater comprising:
an electrode cartridge removably couplable to a housing, the electrode cartridge comprising a plurality of electrodes configured to generate oxidizing agents when powered; and
the housing comprising:
an electrical connection to a power source; and
a plurality of electrode terminals in electrical communication with the power source via the electrical connection, the plurality of electrode terminals configured to electrically engage with the plurality of electrodes in a wet connection to provide power to the plurality of electrodes from the power source.

2. The water sanitation system of claim 1, wherein the plurality of electrodes have first ends and second ends, the first ends attached to a top portion of the electrode cartridge, the second ends attached to and extending through a bottom portion of the electrode cartridge.

3. The water sanitation system of claim 2, wherein the top portion of the electrode cartridge removably secures to the housing.

4. The water sanitation system of claim 2, wherein the plurality of electrode terminals comprise spring arms configured to frictionally engage the second ends of the plurality of electrodes in the wet connection.

5. The water sanitation system of claim 1, wherein the electrical connection comprises a power socket configured to receive a power cable, the power cable electrically connected to the power source, the plurality of electrode terminals electrically connected to the power source via the power socket and the power cable.

6. The water sanitation system of claim 1, wherein the housing comprises a housing base, the housing base configured to be watertight.

7. A water sanitation system for use in saltwater comprising:
a base comprising an electrical connection to a power source; and
a housing removably couplable to the base, the housing comprising a plurality of electrodes configured to generate an oxidizing agent when powered, the plurality of electrodes configured to receive power wirelessly from the power source through the housing and the base.

8. The water sanitation system of claim 7, wherein the base further comprises a first induction element and the housing further comprises a second induction element, the plurality of electrodes of the housing configured to receive power wirelessly via the first and second induction elements.

9. The water sanitation system of claim 8, wherein the housing further comprises a water monitoring sensor.

10. The water sanitation system of claim 9, wherein the water monitoring sensor is configured to measure an indication of chlorine concentration of the saltwater and transmit data wirelessly.

11. The water sanitation system of claim 10, further comprising:
a first near field communications (NFC) antenna located in the base; and
a second NFC antenna located in the housing, the first NFC antenna and the second NFC antenna configured to transmit the data from the water monitoring sensor to the base.

12. The water sanitation system of claim 11, wherein;
the first induction element and the second induction element are oriented radially to each other; and
the first NFC antenna and the second NFC antenna are oriented axially to each other.

13. The water sanitation system of claim 7, wherein the base and/or the base comprises one or more connection clips configured to removably couple the housing and the base.

14. The water sanitation system of claim 7, wherein:
the housing further comprises an identification chip; and
the base is configured to wirelessly receive data from the identification chip.

15. The water sanitation system of claim 7, wherein the base and the housing are configured to be located at one of: a spa well, in a filter well, below the filter well, in a sidewall of a spa, in a spa rail, or in a jet/light recess.

16. A water monitoring sensor comprising:
a water monitoring element configured to measure one or more properties of water; and
a first inductive element in electrical communication with the water monitoring element and a second inductive element, the first inductive element configured to:
receive power wirelessly from the second inductive element and provide the power to the water monitoring element; and
transmit data wirelessly to the second inductive element using the first inductive element, the data comprising the measured one or more properties of water.

17. The water monitoring sensor of claim 16, wherein the first inductive element is configured to transmit data wirelessly to the second inductive element using a first protocol.

18. The water monitoring sensor of claim 17, wherein the first protocol is a frequency modulated protocol.

19. The water monitoring sensor of claim 16, wherein the water monitoring element is configured to measure one or more of an oxidation reduction potential, a PH, a temperature, a conductivity, or a concentration of halogens.

20. The water monitoring sensor of claim 16, wherein the first inductive element is configured to:
receive data wirelessly from the second inductive element via a first protocol; and
transmit data wirelessly to the second inductive element via a second protocol different than the first protocol.
